(19) United States
(12) Patent Application Publication
(10) Pub. No.: US 2007/0262195 A1
(43) Pub. Date: Nov. 15, 2007

(54) UAV With Control and Stability System

(76) Inventors: Robert Bulaga, Folsom, CA (US); Timothy Worley, Sunnyvale, CA (US)

Correspondence Address: THELEN REID BROWN RAYSMAN & STEINER LLP, 2225 EAST BAYSHORE ROAD, SUITE 210, PALO ALTO, CA, 94303, US

(21) Appl. No.: 11/746,628

(22) Filed: May 9, 2007

Related U.S. Application Data
(60) Provisional application No. 60/746,989, filed on May 11, 2006.

(51) Int. Cl. B64C 29/00

(52) U.S. Cl. 244/12.4

(57) ABSTRACT

Disclosed is a remotely controlled aircraft configured to vertically take-off and land. The aircraft includes a pair of propulsion devices that are mounted on an airframe above the level of the center of gravity. A set of control devices are mechanically linked to the propulsion devices for varying the orientation of the propulsion devices during flight. Roll right-left fan speeds up, right fan slows down; Roll left-left fan slows down, right fan speeds up; Pitch forward/aft both fans move forward or aft; Yaw-one fan moves forward one fan moves back depending on the direction CW or CCW; Change altitude—both fans speed up or slow down.

### CROSS-REFERENCE TO RELATED APPLICATION

This application claims benefit of and incorporated by reference U.S. Patent Application No. 60/746,989 filed May 11, 2006 entitled “Oviwun UAV” by inventors Robert Bulaga et al.

### BACKGROUND OF THE INVENTION

1. Field of the Invention

The present invention related to the field of aircraft. More particularly the field of unmanned vehicle systems or unmanned air vehicles. The present invention is related to electrically powered vertical take-off and landing unmanned vehicle systems that are controlled through the use of shrouded propellers which can be titled about their axis individually and the rotation speed to the propellers varied to give control over the vehicle.

2. Description of the Related Art

There are numerous unmanned vehicle systems and unmanned air vehicles currently in use. For example, one type of design comprises a conventional type of aircraft having a propulsion device, such as a fan unit, and a plurality of flight surfaces, such as wings, extending outwardly there from. Such unmanned systems generally require a long take off or landing strip making the unable to take-off or land in tight or confined spaces. Additionally such aircraft must circle to maintain position over a target of interest. This makes these aircraft unsuitable for use in urban areas where the availability of take-off and landing strips of sufficient length and clearances are not available.

Another type of design for unmanned vehicle systems is an aircraft having a propulsion device, such as an exposed rotor or stacked rotors, located above and to the center of the aircraft, with or without a fan or fans on the aft end of the aircraft. These aircraft have the ability to virtually take-off and land vertically. However, the rotor is as large as or larger than the width of the vehicle and nearly has large or larger than the length of the vehicle. While this exposed rotating propeller design is acceptable in a vehicle where the rotor is sufficiently clear of any people or objects which in may come in contact with, when adapted to smaller unmanned vehicle systems it presents a very great hazard to persons and property. The exposed rotor makes it difficult to approach the aircraft upon take-off or landing. The operator must wait until the rotor has stopped rotating before it is safe to approach the vehicle.

Additionally such aircraft also find operating in the urban environment difficult, if not impossible. Another drawback of the exposed rotor, which extends beyond the body of the aircraft, is that it can easily come into contact with people or obstacles during flight operations. When the exposed rotor does come into contact with people or obstacles during flight is almost always leads to catastrophic failure of the aircraft; and may also lead to dead or dismemberment of an individual, or the destruction of obstacle it comes in contact with.

Another type of design for an unmanned vehicle system is an aircraft having a single propulsion device located within the shroud. Such an aircraft may or may not have additional flight surfaces, such as wings extending outward from the shroud. That in the case of such vehicles the shroud itself becomes the fuselage and body of the aircraft. While such an aircraft does not have the hazards associated with the exposed rotor of the previous example, it does have the drawback of having only a single source of thrust through the shroud. This means that the aircraft must rotate the entire fuselage in the direction it wishes to travel. This places the sensors on the aircraft in a new orientation to the ground. The sensors must then the rotated to maintain a target of interest or their orientation to the ground.

An additional drawback to such a design is that the vehicle must pull up to stop or roll forward to achieve forward flight. This can only be accomplished when the vehicle is already moving, thus its ability to stop quickly is greatly reduced or non-existent. Without this ability to stop or start on short notice the aircraft can lose the target of interest if the target of interest chooses to stop or start suddenly.

There is therefore a need for a unmanned air vehicle system which has the ability to operate launch and recover vertically without the use of any exposed rotors, and have the ability to remain essentially level through out the entire flight envelope.

### SUMMARY OF INVENTION

The aforementioned needs are satisfied by the present invention which relates to an aircraft configured as an unmanned vehicle system. The aircraft is comprised of a fuselage that advantageously maintains the same upright orientation during both take-off and landing and during the entire flight envelope. The aircraft comprises two shrouded counter-rotating propellers within the shrouds which are positioned laterally higher than the vehicle's center of gravity. These shrouds rotate about a common axis providing pitch and yaw control. These shrouded propellers both protect the propellers and keep them from coming into unwanted contact with people or obstacles, thus reducing the potential for a catastrophic failure of the aircraft or may also lead to the death or dismemberment of an individual, or the destruction of obstacle it comes in contact with.

In the preferred embodiment, a pair of propulsion devices, such as dual counter-rotating shrouded propellers, are attached to the airframe near the upper most edge of the airframe for providing life and propulsion to the aircraft. The propulsion devices are desirably configured to rotate, together or individually, around a common axis thereby controlling the aircraft during flight. Preferably a majority of the aircraft fuselage hangs below the common axis on which the propulsion devices are mounted. This allows the aircraft fuselage to maintain its orientation to the ground through out the entire flight envelope offering a stable platform for sensor package or packages.

The aircraft also includes a control and stability system.

### BRIEF DESCRIPTION OF THE DRAWINGS

FIG. 1 is a diagram illustrating software of the control and stability system;

FIG. 2 is a diagram illustrating control flow of the system;

FIG. 3 is a flowchart illustrating a method of controlling an aircraft;

FIG. 4 is a diagram illustrating an aircraft capable of being controlled using the system; and

FIG. 5 is a diagram illustrating the aircraft from the rear.

### DETAILED DESCRIPTION

### Control and Stability System

### Overview

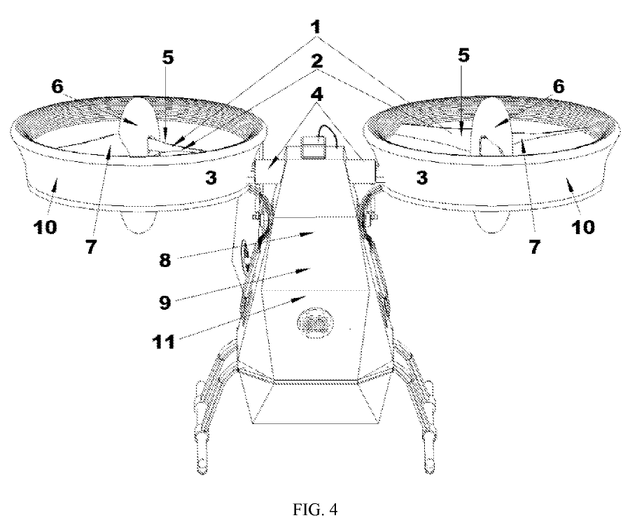

Oviwun has an on-board stability and control system. The vehicle utilizes a sensor suite to monitor its state. The normal state is upright, the shrouded propellers are parallel to the ground and the body is perpendicular ground, as seen in FIG. 4. The stability and control system can report the vehicle's state three different ways depending on the mode of operation:
(1.) rate based state-expressed in degrees per second
(2.) attitude based state-expressed in degrees
(3.) position based state-expressed as a desired position in free space

Position may be relative to a fixed starting point and measured in feet or meters. or absolute and expressed in longitude, latitude, and altitude above sea level. Although the expression of the unit may change, the basic response of the vehicle is the same.

Movements and the speed of the vehicle (in all directions) are achieved by adjusting the tilt of Oviwun's two shrouded propellers and the speed of the two motors. When perturbed; whether during take off, in-flight, or landing; deviations in the vehicle's normal state (body tilt) are detected by the sensor array. The detected deviations are sent to the vehicle controller. The vehicle controller corrects these deviations by utilizing the flight controls to counter-act the variations measured the sensor array.

### Control

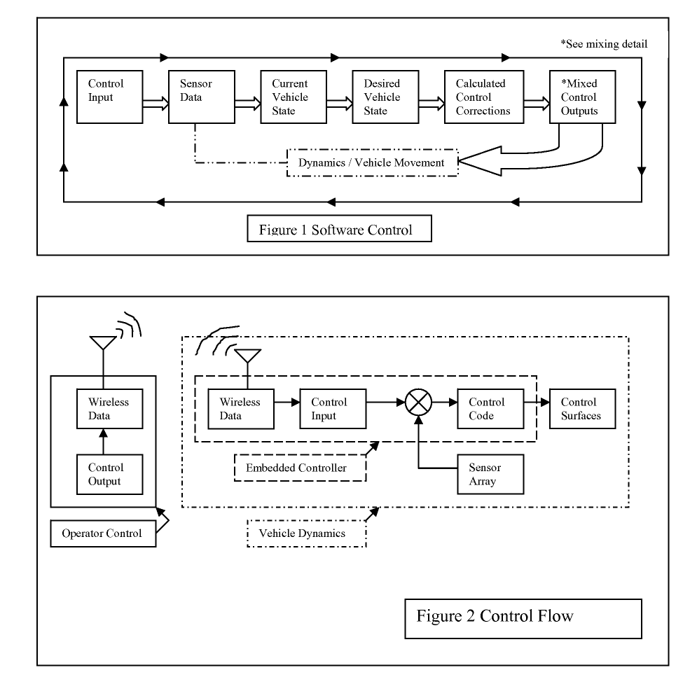

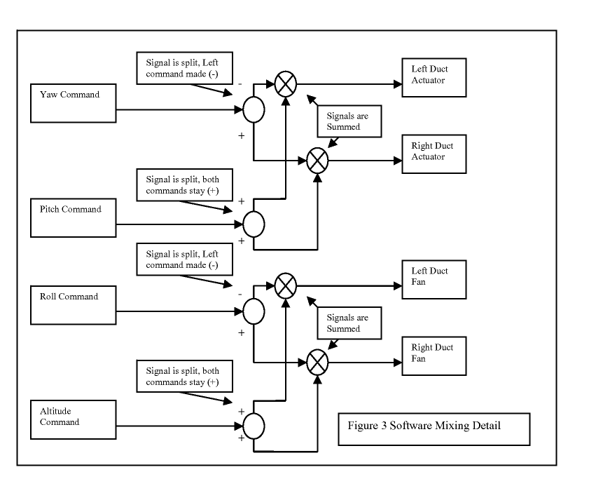

The machine is controlled by an operator, by issuing a state change via a wireless remote. (FIG. 2 Control Flow) By varying the vehicle's normal state, the operator can cause movement in the following directions: forward, backward, right, left, clockwise, counter-clockwise, up, and down. Movements of the vehicle are expressed as roll (left or right), pitch (fore or aft), yaw (clockwise or counter-clockwise) and altitude (up or down). Also the speed of the movements (change in direction/change in time) can be controlled by the amount of control deflection. Pitch and yaw are controlled by the two shrouded propellers rotating about their common axis. Altitude and Roll are controlled by increasing or decreasing the motor speed. To change the vehicle position, the operator sends a state change command. For example to move forward, the operator would change the normal state to allow the vehicle's shrouded propellers to tilt forward while the body continues to remain upright. The resulting change in the thrust vector would cause the machine to move forward. The speed of the movement would be determined by the amount of forward duct tilt. These four movements Roll, Pitch, Yaw, and Altitude occur as follows:

### Altitude

Altitude, movement up or down, is set by controlling the speed of both left and right motors. Fan speed is expressed in Revolutions per Minute (RPM). In order for the machine to rise up or down without moving to the left or right, both fans must increase or decreased the same amount of RPM. Failure to increase the RPM the same amount would cause the machine to roll to the left or right. To raise the altitude, the RPM of each fan is increased. To reduce altitude, the RPM of each fan is decreased.

### Roll

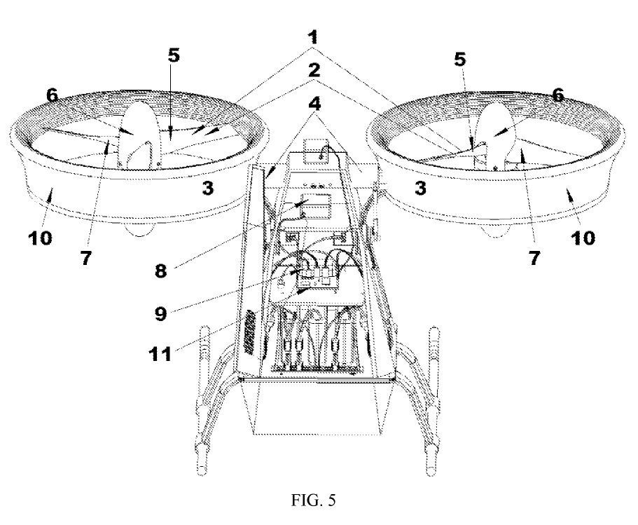

Roll is defined as the left-right movement of the machine as viewed from the rear (see FIG. 5) and is controlled by increasing RPM of one fan, while simultaneously decreasing the RPM of the opposite fan the same amount. The uneven thrust creates a left or right direction change depending on which motor RPM is increased or decreased. Because the shrouded propellers are fixed to the body centerline at right angles in this axis, the body must tilt to achieve Roll maneuvers. Roll control is the only axis change that affects the body angle.

### Roll and Altitude Mixing

Roll and altitude are controlled by the left and right motor RPM. Due to this fact, the roll and altitude controls must be mixed together and the combined output sent to the control surfaces. Mixing is achieved by summing the roll and altitude commands going to each motor separately. Mixing is essential, this allows the machine to share resources (the motors) and execute compound maneuvers. The summing matrix is shown in FIG. 3—Software Mixing Detail. For example the machine can gain altitude and roll left at the same time. This is achieved by summing the altitude and roll command (see FIG. 4 and FIG. 5). Both motors will increase (+) motor RPM to gain altitude. At the same time the roll left requires the left motor to decrease (−) RPM and the right motor to increase (+) RPM. The summing of these commands will cause both left and right motors to increase RPM, but not the same amount. The left motor will have a slightly lower RPM due to the concurrent roll left.

### Pitch

Pitch is controlled by rotating the two shrouded propellers in the same direction. This rotation about the common axis, redirects some of the motors thrust causing the machine to respond in Pitch. The fans are moved together in the same direction and vehicle responds in pitch, moving forward if both control surfaces are tilted forward, and rearward if both control surfaces are tilted back. The speed of the movement is determined by the amount of control deflection. If the control surfaces are not moved the same amount a Yaw (heading change) will occur.

### Yaw

Yaw (heading) is controlled by rotating the two shrouded propellers in opposite directions. This rotation, no longer perpendicular to the vehicle body, redirects some of the motor's thrust causing the machine to respond in Yaw. Yaw control utilizes the same two controls as Pitch. Yaw is controlled in the following manner: As viewed from the top of the machine, Yaw, clockwise (CW) and counter-clockwise (CCW), movements are controlled by moving the shrouded propellers in opposite directions. To create a Counter Clock Wise (CCW) movement the left fan is tilted rearward and at the same time the right fan is moved on the opposite direction, forward. The amount of movement of each fan is the same but in opposite directions. To create a Clock Wise (CW) movement the left fan is tilted forward and at the same time the right fan is moved on the opposite direction, rearward. The speed of the rotation is determined by the amount of deflection.

### Pitch and Yaw Mixing

Pitch and yaw control utilize the same control surfaces simultaneously in different ways to maintain the forward/aft (Pitch) and CW/CCW (Yaw) control. In order to do this the pitch and yaw commands must be mixed. Mixing is achieved by summing the pitch and yaw command going to each ducted fan separately. The left pitch and yaw is combined independently of the right Pitch and Yaw commands. The summing matrix is shown in FIG. 3—Software Mixing Detail. Note that the signs of the left right Pitch commands are the same and the signs of the Yaw command are opposite. Changes can be carried out at the same time by mixing or summing the two control outputs. For example if the machine were required to move forward and rotate CCW at the same time the following sequence would occur. The controller (Item 9), having determined that the machine needed to rotate CCW and move forward, has processed two separate commands to do so. The controller combines the signals by adding the right duct positive (+) Pitch and right duct positive (+) Yaw. The controller also adds the left duct positive (+) Pitch command with the right duct negative (−) Yaw command. The sum of each is sent to its respective actuator. Note that left and right Pitch commands are always the same sign and left and right Yaw command are always opposite signs. (FIG. 3)

### Stability

The vehicle body is prevented from drifting away from its commanded state by a stability augmentation system. The vehicle dynamics require constant monitoring to avoid loss of stability. Errors in the vehicle's state are detected by the sensor array. The controller uses the sensor data to automatically correct the state errors. The controller uses the machine's controls (fan tilt and motor RPM) to correct state errors and maintains the vehicle's stability. The combination of state errors and command signals are used to determine control response of the vehicle. (See FIG. 2)

The controller utilizes an embedded processor to control all of the vehicle's functions. This controller executes code that runs in a continuous loop. (FIG. 1 Software Control) The loop reads the control inputs and sensor array data, tracks the desired vehicle state, calculates the current vehicle state, and uses current and desired state information to calculate control corrections and mixes output signals to the left and right motors and the left and right ducts. Loop rates may vary from 10 to 50 cycles per second depending on the mode of operation.

The aircraft takes-off and lands vertically to eliminate the need for take-off or landing strips. Additionally, the airframe is compact and has a relatively small footprint so that ground storage and transportation needs are minimized. The shrouded nature of the propellers also allows the aircraft to get near to and even come in contact with obstacles without causing damage to the aircraft or obstacle, while still being able to maintain its flight regime and carryout its mission.

The shrouded propellers are located laterally and counter-rotate. The shrouds are located higher than the aircrafts center of gravity. The propellers rotate along a common axis, together for pitch control, individually for roll control. The blades of the propellers may be fixed. In an embodiment there are electric motors within the center of the shrouds driving the propellers. The aircraft has onboard sensors to determine attitude and altitude. Shrouds are located at least about 75% of their exit diameter above a ground plane. Onboard electronics and sensors housed within the fuselage remain essentially level during flight.

In one aspect of the invention, there is an operator controlling the aircraft by sending signals to the aircraft through wireless technology, signaling the aircraft to vertical take-off or land, additional signal inputs from operator sends a signal or multiple signals to the aircraft control system which interprets the commands, and adding or subtracting the signaled inputs from the data generated by the system to keep the system in its normal relationship to the ground, causes the propulsion devices, mounted on the upper portion of the airframe and those propulsion devices each being rotatable about a common axis of rotation, to move, together or independently, and to speed up or slow down the rotation of the propellers within the shrouds, to control the movement of the aircraft.

The aircraft offers a safe means of transporting sensors and/or cargo between locations. The aircraft is stable during flight offering an essentially level platform for the sensor package which does not appreciable change with the movement of the aircraft. The extremely compact size of the aircraft offers a small foot print so that the aircraft can be operated in tight quarters and even a modest amount of foliage without damage to obstacles near the aircraft.

What is claimed is:

1. A remotely controlled, vertical take-off and landing aircraft, comprising:
An airframe configured to support on board electronics, batteries, and control actuators, the airframe being symmetric about a medial;
a pair of propellers mounted on an upper end of the airframe, the propellers each being tiltable about a common axis, wherein the propellers are positioned symmetrically with respect to the medial plane and wherein each of the propellers are rotatably mounted within a shroud;
a motor mounted within the centerbody of each shroud, each motor drivingly coupled to the propeller within that shroud;
and a movable control on the airframe, the control coupled to the pair of propellers so that the propellers tilt about the axis in response to movement of the control.

2. The aircraft as in claim 1 wherein the propellers rotate in opposite directions.

3. The aircraft as in claim 1 wherein each of the propellers comprises fixed pitch rotor blades.

4. The aircraft of claim 1 wherein a pair of propellers may be tilted about the axis in the same direction in response to the control.

5. The aircraft of claim 1 wherein the pair of the propellers maybe tilted about the axis in opposite directions in response to movement of the control.

6. The aircraft of claim 1 wherein the speed of the propellers varied together to control vertical movement.

7. The aircraft of claim 1 wherein the speed of the propellers maybe varied individually to control roll movement.

8. A vertical take-off aircraft comprising: an airframe; a pair of shrouded propeller assemblies movably mounted on opposite sides of the airframe, each shrouded propeller assembly comprising a shroud, a propeller with a plurality of propeller blades disposed within the shroud; a pair of actuators mounted between the airframe and each of the pair of shrouded propeller assemblies, the actuators configured to rotate each of the pair of shrouded propeller assemblies about a lateral axis through each of the pair of shrouded propeller assemblies; and a control system connected to the pair of actuators, the control system configured to drive the actuators to produce changes in the direction of the airflow out of the bottom of each of the pair of shrouded propeller assemblies, such changes in airflow direction being used to control the attitude of the aircraft.

9. The aircraft of claim 8 further comprising a pair of actuators mounted on the airframe and attached to each of the pair of shrouded propeller assemblies, the actuators configured to rotate each of the pair of shrouded propeller assemblies about a lateral axis through each of the pair of shrouded propeller assemblies.

10. The control system of claim 8 wherein the controller is further configured to drive the actuators in the same direction to control the pitch of the aircraft.

11. The control system of claim 8 wherein the controller is further configured to drive the actuators in opposite directions to control the yaw of the aircraft.

12. The control system of claim 8 where in the controller is further configured to alter motor speed in unison to control the altitude of the aircraft.

13. The control system of claim 8 wherein the controller is further configured to alter the motor speed differentially to control the roll of the aircraft.

14. A vertical take-off aircraft comprising: an airframe; a pair of shrouded propeller means for producing thrust disposed upon opposite sides of the airframe; tilting means for altering the orientation of the pair of shrouded propeller means relative to the airframe; and control system means for driving the control tilting means.
